(19) United States
(12) Patent Application Publication
(10) Pub. No.: US 2008/0172418 A1
(43) Pub. Date: Jul. 17, 2008

(54) METHOD AND SYSTEM OF COMPILING AND DISTRIBUTING PROPERTY LISTING DATA

(76) Inventors: John Matthew Beck, Parrish, FL (US); Chris Latko, Sarasota, FL (US); Keith Hanenian, Sarasota, FL (US)

Correspondence Address: MCCORMICK, PAULDING & HUBER LLP, CITY PLACE II, 185 ASYLUM STREET, HARTFORD, CT, 06103, US

(21) Appl. No.: 12/013,029

(22) Filed: Jan. 11, 2008

Related U.S. Application Data
(60) Provisional application No. 60/884,507, filed on Jan. 11, 2007.

(51) Int. Cl. G06F 17/00

(52) U.S. Cl. 707/104.1; 707/E17.032

(57) ABSTRACT

An embodiment of the present invention is a method of compiling and distributing property listing data. The method includes obtaining regional real estate listings, compiling the regional real estate listings to create an aggregate listing database, and assigning real estate brokers to specific real estate listings within the aggregate listing database. The method also involves providing the real estate brokers with leads generated through consumer access to the aggregate listing database. An additional embodiment of the present invention is a method of providing real estate listing information to consumers. The method includes obtaining listing data for a property, obtaining third party data for a property, and linking the listing data and the third-party data. The linked data is then provided to consumers.

### CROSS REFERENCE TO RELATED APPLICATIONS

This application claims the benefit of U.S. Provisional Application Ser. No. 60/884,507, filed on Jan. 11, 2007, hereby incorporated by reference in its entirety.

### FIELD OF THE INVENTION

The present invention relates generally to a method and system of compiling and distributing property listing data and more specifically to a method for making a national real estate listing database available to regional or local real estate brokerages and providing satellite images of listings.

### BACKGROUND OF THE INVENTION

Information regarding property listings is available on the Internet through brokers offering access to regional Multiple Listing Services, (“MLS”). MLSs are regional databases containing property listings that are owned by the local Boards of Realtors, referred to herein as a “board,” or their contracted service providers. The listings contained within the regional MLS databases are the explicit property of the member brokers. In order to gain access to the regional MLS database for any given area, a broker must possess a valid Real Estate Broker's license for that state, be a member of and in good standing with the local board, and sign an IDX/VOW contract.

Each local board is required to adopt the National Association of Realtors, (“NAR”), recommended guidelines known as IDX/VOW for granting MLS data access. IDX stands for Internet Data Exchange, and is essentially a contract that lets a broker allow free access to the MLS listings via a Web site, but with key information kept private such as the property address and agents' descriptions. VOW or Virtual Office Web site contracts differ somewhat in that they do not possess the same data restrictions; however, the user must “register” his contact information and e-mail address with the broker and be provided a password in order to gain access to the site.

Additionally, Internet-based property searching is an increasingly effective way of generating lucrative leads for brokers. Statistics indicate that 77% of home buyers now use the Internet in their home search and approximately 75% of buyers and sellers will work with the first agent with which they speak. Moreover, Internet home searchers are approximately 20% more likely to use a Realtor as opposed to those who do not use the Internet, with 8 out of 10 searchers (81%) actually hiring a Realtor to assist with the transaction. Furthermore, Internet home searchers have a median income approximately $20,000 higher than those who do not utilize the Internet and, by extension, also purchase more expensive homes.

Only a handful of brokerages, however, offer national MLS searches and are able to fully capitalize on the large number of leads generated through Web-based searching. The difficulty of aggregating the 745 MLS databases is why there are few sites that offer national MLS searching besides Realtor.com™, the site owned by the National Association of Realtors. NAR does not, however, possess a national-level aggregated MLS database that can be licensed; their data is obtained from a third-party. As will be appreciated, Realtor.com does not capture and route leads due to the fact that it is owned by the NAR and do not benefit any one player. As such, only a few large, national brokerages offer national MLS searching and are able to take advantage of the numerous leads generated through Internet searches.

Further, realtors commonly spend entire days driving clients around looking at homes that meet the desired price and features, only to have the clients reject the home due to its view or proximity to some special location such as major roadways, schools, etc. There are currently no MLS search tools that allow clients to view the properties on both a traditional overhead road-map and on a high-resolution satellite map to ensure that a property meets their geographic criteria.

In view of the above, there is a need for smaller, non-national brokerages to be able to offer Web-based national MLS searching to generate significant leads from Internet property searches. There is also a need for displaying MLS information via overhead aerial maps, e.g., a satellite map, and making such information available via the Internet and GPS enabled mobile devices such as phones and PDAs. The present invention fulfils these needs and more.

### SUMMARY OF THE INVENTION

It is an object of the present invention to provide a national MLS searching system.

It is another object of the present invention to provide a national MLS searching system via the Internet.

It is yet another object of the present invention to provide an international real estate searching system.

It is an additional object of the present invention to provide a national MLS searching system to smaller, non-national real estate brokerages so that they may effectively generate leads from Internet-based property searches.

It is yet another object of the present invention to display MLS information via an aerial map.

It is an object of the present invention to display MLS information via satellite mapping.

It is a further object of the present invention to make MLS information available via the Internet and GPS enabled mobile devices such as phones and PDAs.

It is yet another object of the present invention to provide a national MLS system to non-national brokerages that allows clients to view a property using aerial mapping, including satellite mapping, via the Internet or a GPS enabled mobile device.

An embodiment of the present invention is a method of compiling and distributing property listing data. The method includes obtaining regional real estate listings, compiling the regional real estate listings to create an aggregate listing database, and assigning real estate brokers to specific real estate listings within the aggregate listing database. The method also involves providing the real estate brokers with leads generated through consumer access to the aggregate listing database.

An additional embodiment of the present invention is a method of providing real estate listing information to consumers. The method includes obtaining listing data for a property, obtaining third party data for a property, and linking the listing data and the third-party data. The linked data is then provided to consumers.

### BRIEF DESCRIPTION OF THE DRAWINGS

FIG. 1 is a schematic diagram illustrating a system in accordance with an embodiment of the present invention.

FIG. 2 is flowchart illustrating steps of creating a national MLS listing database from regional data as accomplished by the system of FIG. 1.

FIG. 3 is a flowchart illustrating steps of providing MLS and third-party data to consumers.

FIG. 4 is a flowchart illustrating steps involved in accessing MLS data utilizing the system of FIG. 1.

FIG. 5A is screen capture of a user interface of the system of FIG. 1 depicting multiple flagged properties contained in a geographic region.

FIG. 5B is a screen capture of the user interface of FIG. 5A depicting detailed information on a specific flagged property.

### DETAILED DESCRIPTION OF THE PREFERRED EMBODIMENT

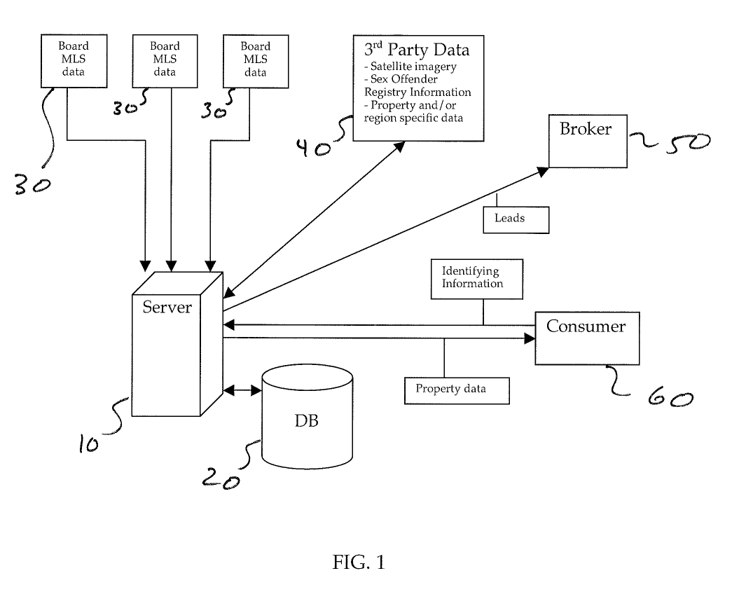

Referring to FIG. 1, a preferred embodiment of the system of the present invention is a system that offers aggregate, national searching of MLS data provided by a network of smaller, non-national real estate brokers. The system includes a server 10 on which resides a database 20.

The server 10 receives regional real estate listing data from, among other possible sources, regional boards of realtors 30. This data is received and stored in the database 20. In addition, the inventive system receives data from various third-party sources 40 which can include, for example, satellite imagery or sex offender data from a state registry. As will be appreciated, other third-party data may be obtained such as weather information, etc.

The system further includes providing information to both brokers 50 and consumers 60 via a Web-based interface or a GPS enabled device. More specifically, consumers 60 can access the property data contained in database 20. If a consumer wishes to obtain additional information regarding a specific property, or would like to comment on a specific property, he or she can leave identifying information which would be stored in the database 20. The identifying information is then provided to the broker 50 who is assigned to the specific property as a sales lead.

As will be appreciated, this is an important aspect of the present invention in that it allows small non-national brokerages to capitalize on the large number of leads generated through Internet-based property searching and effectively compete with the large national brokerages.

Moreover, the inventive system also provides aerial satellite maps to consumers so that they can determine whether a specific property meets their geographic criteria. This is accomplished by combining the real-time MLS data with third-party data from easy-to-use interfaces such as Google Maps, Google Earth, and Windows Live. In addition, the system can provide the above-described information to any Internet enabled phone, PDA, or the like.

These features are important aspects of the present invention as realtors and consumers will save enormous amounts of time spent driving around to gain information about a property that can now be obtained online.

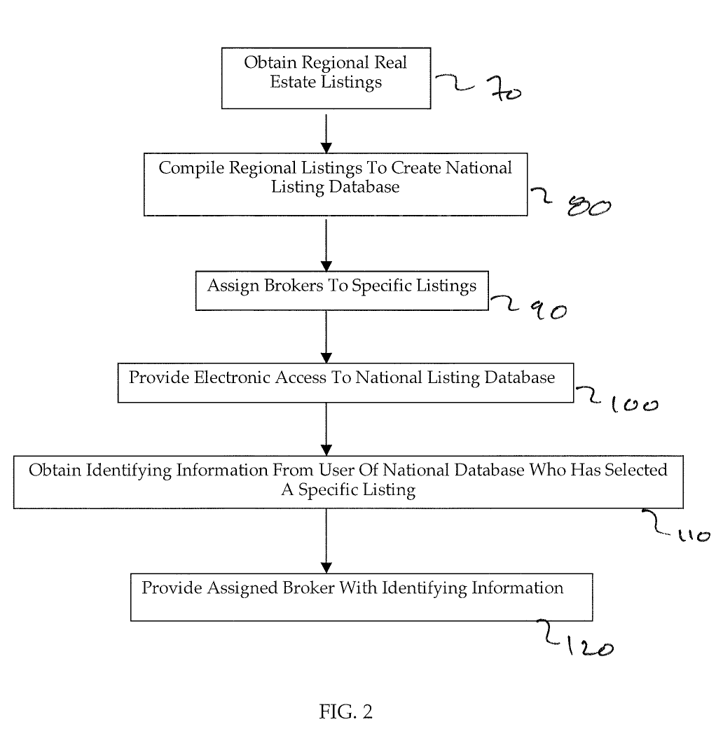

Referring now to FIG. 2, the system of the present invention involves compiling MLS data from individual brokers to assembly a national MLS database. The first step in this process, step 70, is obtaining the regional listings. At this step, the individual brokers, or boards of realtors, provide access to their MLS data feeds. The data is then compiled at step 80 to create a national MLS database. The brokers are then assigned or linked to specific listings or boards of listings at step 90. The database is then made available to consumers which is depicted at step 100. Consumers wishing to obtain additional information regarding a specific property, must then leave identifying information such as an email address (Step 110). Finally, at step 120, the individual brokers are routed all leads, i.e., identifying information of consumers, that are captured for the areas they are exclusively linked to.

Additionally, the system can be utilized to implement a broker's own IDX/VOW web site and is compliant with existing MLS rules.

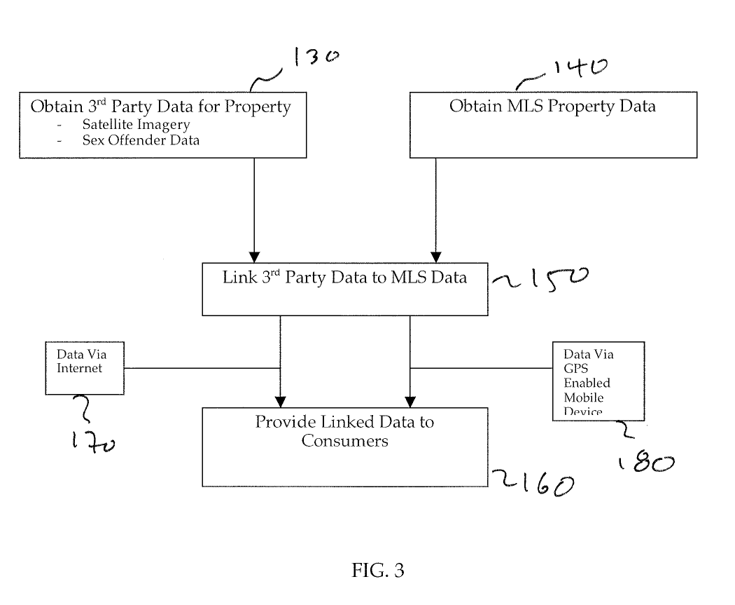

Turning now to FIG. 3, the inventive system receives and combines property data and provides the data to consumers via a web-based interface or through GPS enable devices. More specifically, the system will tie together MLS data, Google maps, and GPS coordinates to provide users an intuitive way to research properties in their proximity using a mobile device. This process involves first obtaining 3^{rd} party data such as satellite map data from Google (step 130) and obtaining MLS property data (step 140). This data is combined or linked at step 150. The linked data is then provided to consumer either via a Web-based interface (step 170) or through a GPS enabled mobile device (step 180).

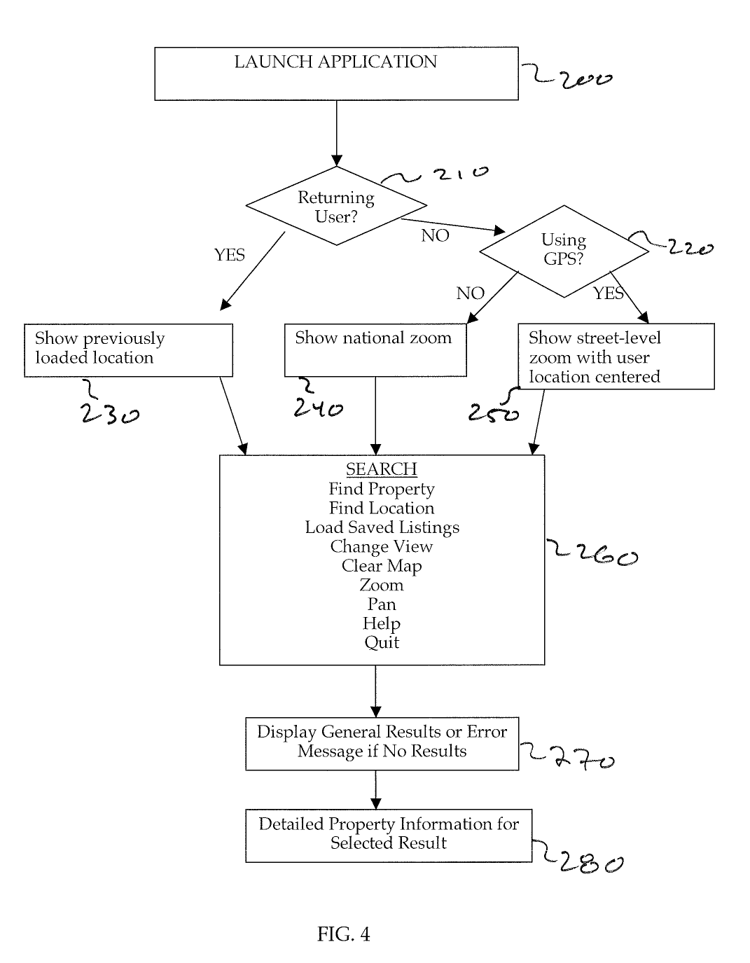

FIG. 4, graphically illustrates a consumer experience using the inventive system. The user will first launch the application (step 200). The application is typically launched through the Web. The application then determines whether the consumer is a returning user (step 210). If the consumer is a returning user, the previously loaded location will be displayed (step 230). If the user if not returning, then a determination of whether the user is utilizing GPS is made (step 220). If the user is not using GPS, a national map will be displayed (step 240). If the user is using GPS, a street-level view with the user's location will be displayed (250).

At this point, the consumer can choose from the search menu (260) which includes multiple options including: find property, find location, load saved listings, change view, clear map, zoom, pan, help and quit. If the user searches for a property, the results will be displayed (step 270). If no results are obtained an error message is generated (step 280).

When first accessing the user interface, a map of the United States is displayed. The central table is consulted and all state capitals receive a flag or pushpin. Moving a computer mouse over a pushpin reveals the number of each type of property within each state. Clicking on the state pushpin triggers a call to the database to fetch 20 locations within the state with the largest number of properties. The map then zooms in close enough to just display all 20 locations, which are marked with location pushpins or flags. While the present invention is described as providing 20 locations, it will be appreciated that greater or fewer locations may be displayed.

The location pushpins or flags work in the same fashion as the state push pins. That is, they display the number of each type of property when rolled over and zooming in to the respective area when clicked. For example, when a user clicks on ‘Punta Gorda’, he or she will see the first 40 properties in this area based on price description. Also, all property types are shown by default so as to not confuse the user with conflicting numbers between city/listing view. The filter tab is now highlighted so the user can filter the properties down or change the sort order. Clicking on a property will pull up the bubble in the usual way and clicking on “details” will bring the user to the details page. If the user does register and the IDX description is not available, a message saying “No description is available” is displayed. Once the user is on the details page, she can click prev/next in the paging area, or back to return to the map in the previous view.

In addition, the display map is segregated into several zoom levels which determine what type of data to display. If the zoom level is below 6, only states display. If the zoom level is above 6, but below 11, the cities display. Anything above 11 displays listings. The database is queried and the map is repopulated every time the USER moves the map or zooms in/out. Many times the map will move/zoom automatically, but these actions do not trigger a map update. When a map update occurs, the non-normalized aggregate tables are consulted to pull record sets, greatly increasing performance.

The database is queried using the map boundaries and, if at the listing level, the filters specified by the user. So the map functions at each level works like this: 1) State level—states within the visible map boundary will display 2) City level—the top 20 cities within the visible map boundary will display 3) Listing level—the top 40 listings within the visible map boundary will display Another layer of complexity is not mixing the datasets when at the listing level. What happens to eliminate data mixture is to first query the database for the city closest to the center of the map, find out the boardID that ‘owns’ this city, then pull listings from that board's ‘main’ table.

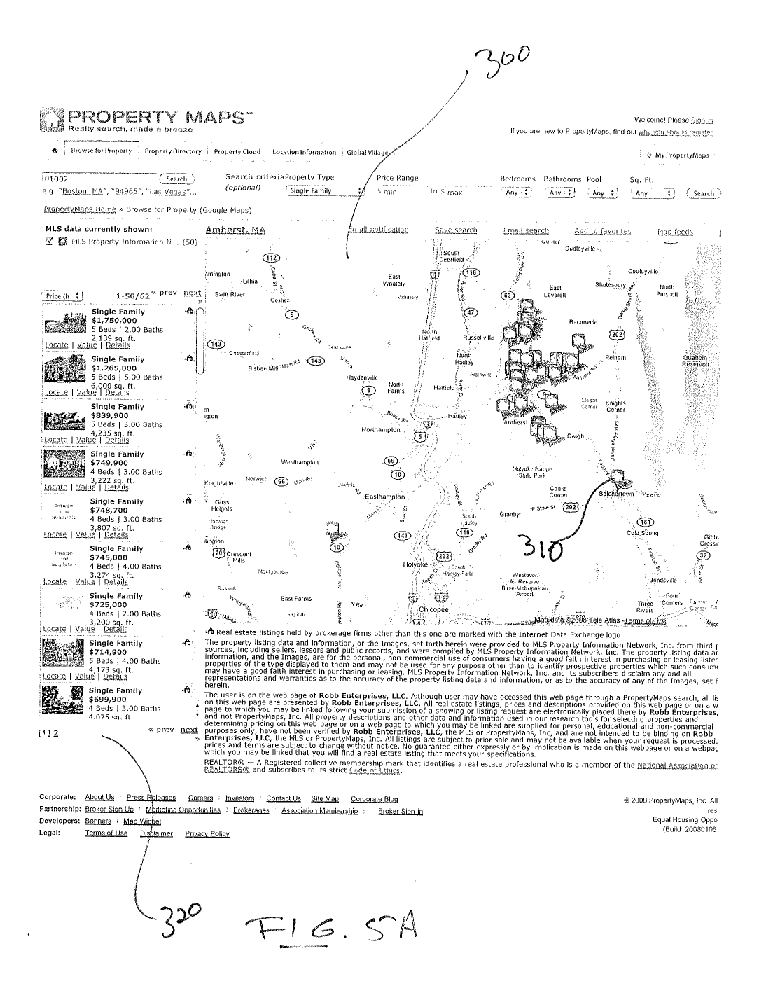

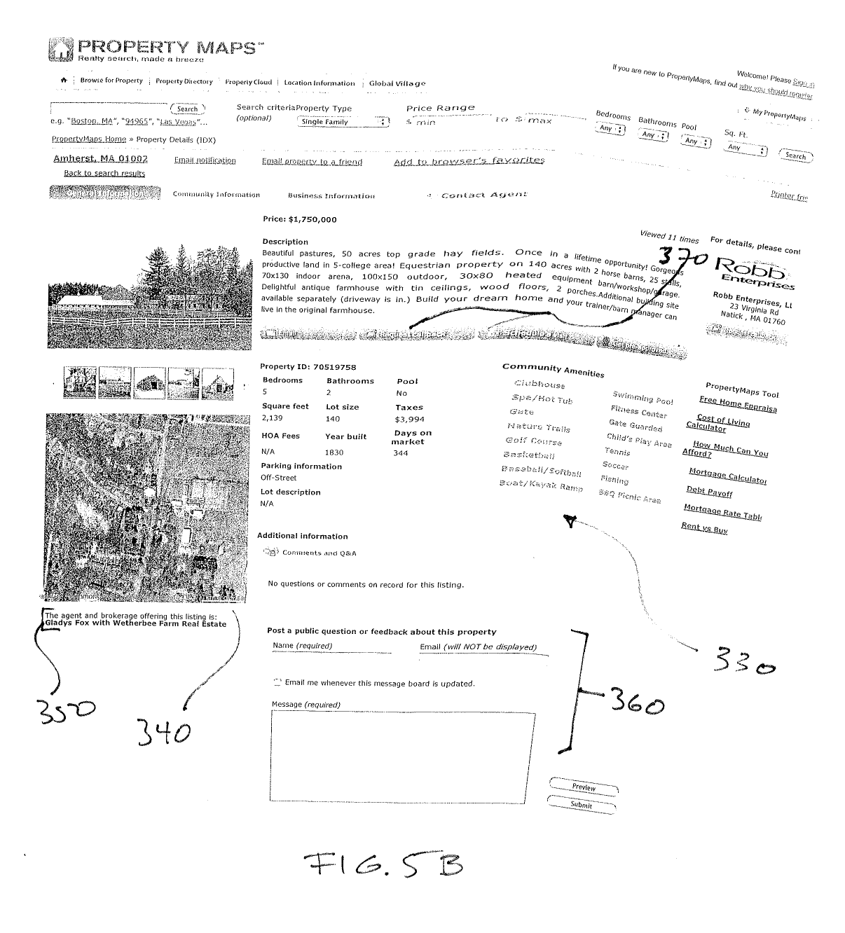

Referring now to FIGS. 5A and 5B, specific locations can also be searched. When receiving a location query, the system determines what type it is: 1) zip code search (all numeric) 2) city only search (non-numeric, without comma) 3) full search (non-numeric, with comma). The system then performs the required search, find out which board is linked to the area, and populate the map from that board's data table.

FIG. 5A is an example of a listings returned after a zip code search. Here the map 300 displays the geographic region corresponding to the entered zip code. The listings within this region are flagged with pushpins 310. A side bar 320 provides brief information regarding the flagged properties. This information may include price, square footage, number of bedrooms, etc.

Turning to FIG. 5B, when a consumer selects a flagged property, information is displayed. IN particular if one clicks on a pushpin, a picture of the property is displayed along with some basic information. If one selects a property from the sidebar 320, the screen of FIG. 5B is displayed.

As shown, the interface includes detailed property information 330. The interface also displays satellite imagery 340 and contains broker information 350. The interface also allows a consumer to post comments or other feedback 360 and to request a callback or schedule a visit 370.

A detailed description of the hardware and software of the preferred system follows.

### Preferred System

The preferred embodiment of the system of the present invention has a toolset that comprised of two components: an administrative tool and a lead management tool. These components reside on the system server, servers as the case may be. Preferably, the administrative tool allows an administrator to 1) Browse/search/edit all MLS boards; 2) add/edit/delete brokers; 3) edit registered website users; 4) review aggregate lead information per broker per board in a dashboard-like format; 5) batch email brokers template or custom emails; 6) batch update broker/board status; 6) add comments to brokers/boards; 7) review a history of changed information per broker or board; 8) review a history of emails sent to each broker; 9) assign admin employees to boards to allow for boards to be distributed amongst a sales team; and 10) assign/delete boards to particular brokers.

When a broker is assigned a board, i.e., a region of real estate listings, the broker's default contact information is automatically added for that board. The administrator or broker then has the option to update this board specific information. The administrator may also specify what zip codes a broker represents of an MLS board if that board is divided by zip codes.

The lead management tool that is offered to brokers in the network allows brokers complete multiple tasks. These include updating default contact information, update board specific contact information, view/update/respond to leads on a per board basis, view total/daily/hourly property webpage views, establish a lead routing system to agents based on property zip code, add comments to leads, view the registration information of the user submitting the lead, view any saved searches or saved properties of the user submitting the lead.

More specifically, the lead management tool is comprised of multiple database tables. The preferred Lead management database tables, with exemplary names, are as follows:
board—holds all MLS board information and is editable through the administrative interface;
board_comment—holds any comments related to a board added via the administrative interface;
board_history—holds all changes to a board that is viewable via the administrative interface;
board_user—holds information on which member of the sales team represents a board;
broker—holds all broker information and is editable via both the admin and broker interface. The broker is only allowed to change his/her own contact information while the admin is allowed to perform additional operations—assign/delete boards the broker represents, add comment, review history, etc;
broker_comment—holds any comments related to a broker added via the admin interface;
broker_email—holds non-editable history of emails sent to a particular broker and viewable through the admin interface;
broker_history—holds all changes to a broker that is viewable via the administrative interface;
broker_zip—holds the zip codes for which a broker represents if a board is divided by zip code; and

board_broker—the bridge table that ties the broker/boards together. This table also holds board specific contact information which is editable by the admin or broker.

An embodiment of the present invention also offers mapping capabilities through a mapping engine. The mapping engine is comprised of two, independently functioning parts: 1) data import routines; and 2) the data display routines. Both import and display routines are described below. For the import of data each dataset gets three directories and a database. The directories are: 1) raw data pulled down from the IDX/VOW server 2) import scripts which format the raw data; and 3) Cron scripts—the daily/weekly scripts to fetch the raw data and trigger the import scripts. Preferably, there is a fourth directory, that provides common scripts for the homogenized data. Each of these scripts, and the data directory are explained below.

The data for each board is downloaded via a cron script into its own database, described below, and then named and moved to the directory the data import scripts expect.

The data is then manipulated by the import scripts. There are two import scripts: 1) Feature/City/County import scripts to create supporting tables; and 2) a main import script which processes the raw data (using supporting tables) and enters data into the ‘main’ table in a common format. At the top of each script are configuration variables such as table name, board id, state; and also include feature mappings where necessary.

The main import script also processes the zip code for each property against the census zip code data to ensure proper city/county information. If the zip code is mangled, it is attempted to be fixed, if that does not work, the city/county from the raw data takes precedence. If the zip code is out of state, the record is tossed. Once the data is homogenized, several other ‘generic’ scripts are run to insert non-normalized data into central tables such as a central MLS listing table which contains data used to display the property information on the mapping. For each incremental dataset, a weekly full update is required.

Each dataset also has at least two cron scripts. The cron scripts are 1) a daily script to retrieve the full text update and run the import scripts; and 2) a weekly script to retrieve the associated photos and run the image resizer script. The image resizer takes all images associated with a datafeed and creates multiple sizes of images for various uses. Incremental datafeeds have an additional weekly script to download the full text update and run the import scripts.

Each feed of IDX/VOW board data has its own database. This database is comprised of at least one table, which contains a standardized set of columns. Other tables within this database are for support when executing the import scripts. Most databases require a ‘feature’ column that maps to the IDX/VOW feature codes. Others may require other tables such as ‘city’ or ‘county’ to map to their respective codes. As will be appreciated, imported data is stored and displayed in a common format and custom import scripts to homogenize the data.

As mentioned above, an embodiment of the system of the present invention also allows national searching and mapping via a GPS enabled mobile device. The capability is accomplished through the use of four distinct components.

The first component is the MLS dataset. This is a homogenized dataset of the participating MLS boards. All data brought into the system will be massaged into a uniform structure. For efficiency reasons, some of this data will be stored in a non-normalized way and may even be duplicated in aggregate structures.

The second component is a Java interface. The Java portion of the application will provide the mapping interface for mobile devices. This interface will have to be adapted to run across differing devices depending on the deployment architecture (MIDP, BREW) and device APIs.

The third components are map tiles which can, for example, come from Google maps street/satellite tiles.

The fourth component is an MLS API. The REST (Representational State Transfer) based API will be used to tie the Java interface to the MLS dataset. URIs with conditional parameters will be used to retrieve XML documents from the MLS dataset.

While many advantages of the present invention can be clearly seen from the embodiments described, it will be understood that the present invention is not limited to such embodiments. Those skilled in the art will appreciate that many alterations and variations are possible within the scope of the present invention.

What is claimed is:

1) A method of compiling and distributing real estate listing data, said method comprising the steps of:
obtaining regional real estate listings;
compiling said regional real estate listings to create an aggregate listing database;
assigning real estate brokers to specific real estate listings within said aggregate listing database; and
providing said real estate brokers with leads generated through consumer access to said aggregate listing database.

2) The method of claim 1 further comprising the steps of:
providing consumers with electronic access to said aggregate listing database;
obtaining identifying information from said consumers; and
providing said brokers with identifying information of consumers interested in said real estate listings linked to said brokers.

3) A method of providing real estate listing information to consumers, said method comprising the steps of:
obtaining listing data for a property;
obtaining third party data for a property;
linking said listing data and said third-party data together; and
providing linked data to consumers.

4) The method of claim 3 wherein said third-party data is satellite images of said property.

5) The method of claim 4 wherein said linked data is provided to consumers via a Web-based user interface.

6) The method of claim 4 wherein said linked data is provided to consumers via a GPS enable mobile device.
